(19) United States
(12) Patent Application Publication
(10) Pub. No.: US 2025/0196180 A1
(43) Pub. Date: Jun. 19, 2025

(54) Coating Apparatus Unit and Method for Producing Granules That Are Functionally Coated With a Coating Agent

(71) Applicant: ADD Advanced Drug Delivery Technologies Ltd., Pratteln (CH)

(72) Inventors: Mirko Nowak, Lörrach (DE); Annette Grave, Lörrach (DE)

(21) Appl. No.: 18/847,723

(22) PCT Filed: Mar. 16, 2023
(86) PCT No.: PCT/EP2023/056808

§ 371 Date: Sep. 17, 2024

(30) Foreign Application Priority Data
Mar. 18, 2022 (DE) 10 2022 106 367.4

(51) Int. Cl. B05C 11/10; B05C 5/02; B05D 1/02

(52) U.S. Cl. CPC B05C 11/1005; B05C 5/0208; B05C 5/0225; B05D 1/02; B05D 2258/00

(57) ABSTRACT

A coating apparatus unit for producing granules that are functionally coated with a coating agent and a method for producing granules that are functionally coated with a coating agent. The coating apparatus includes a coating chamber and a spraying device arranged in the coating chamber for spraying the coating agent. The coating apparatus unit further includes a process analysis tool and an electronic evaluation unit. The process analysis tool is designed to measure the active ingredient content of the granules, which is forwarded to the evaluation unit, so that the increase in mass of the granules can be determined in the evaluation unit by means of the coating agent applied to the granules, taking into account the measured active ingredient content of the granules.

### CROSS-REFERENCE TO RELATED APPLICATIONS

This application is the United States national phase of International Patent Application No. PCT/EP2023/056808 filed Mar. 16, 2023, and claims priority to German Patent Application No. 10 2022 106 367.4 filed Mar. 18, 2022, the disclosures of which are hereby incorporated by reference in their entireties.

### BACKGROUND

### Field

The invention relates to a coating apparatus unit for producing granules functionally coated with a coating agent, comprising a coating apparatus for coating the granules with the coating agent, wherein the coating apparatus comprises a coating chamber and a spraying device arranged in the coating chamber for spraying the coating agent, and wherein in the coating chamber the granules comprising an active ingredient content are or will be coated in a coating process by the spraying device with a quantity of coating agent to form a layer having a layer thickness, and wherein the coating apparatus unit comprises a process analysis tool and an electronic evaluation unit.

Furthermore, the invention relates to a method for the production of granules functionally coated with a coating agent, comprising a coating apparatus unit with for coating the granules with the coating agent, wherein the coating apparatus comprises a coating chamber and a spraying device arranged in the coating chamber for spraying the coating agent, and wherein in the coating chamber the granules comprising an active ingredient content are coated in a coating process by the spraying device with an quantity of coating agent to form a layer having a layer thickness and wherein the coating apparatus unit comprises a process analysis tool and an electronic evaluation unit.

Granules are ideal dosage forms for achieving special drug release profiles. Due to their round shape, smooth surface and narrow particle size distribution, they can easily be functionally coated, e.g. to achieve taste masking, enteric-coated protection or release of the active pharmaceutical ingredient (API) in specific areas of the gastrointestinal tract. The release profile is dependent on the quantity of coating agent applied, which results in the layer thickness of the functional coating itself.

Granules are defined here as powdery, granular or even particulate mixtures that are present in a pourable form (bulk material), expediently consisting of particles, such as granulated particles, agglomerates, pellets or tablets.

### DESCRIPTION OF RELATED ART

In a non-printed state of the art, the coating is carried out using a predetermined quantity of coating agent, which is applied evenly to the granules to be coated during the coating process so that a desired active ingredient release profile can be achieved. After the coating process, the active ingredient content of the granules is then determined in the laboratory by means of analytical content determination as a quality control. The layer thickness is generally not determined. The ratio of theoretical to practical active ingredient content is used to assess the quality of the functional coating. In addition, a release test is carried out in which the proportion of active ingredient released over time is measured. There is usually a correlation between the quantity of coating agent applied, which determines the layer thickness, and the release of the active ingredient. As the quantity of coating agent applied increases, the active ingredient content in the granules decreases. This type of quality control is very time-consuming, costly and human resource-intensive.

### SUMMARY

The task of the invention is therefore to provide a coating apparatus unit and a method for producing granules functionally coated with a coating agent, which overcomes the disadvantages known from the prior art and makes it possible to determine the quantity of coating agent applied to the granules by means of the sprayed coating agent and thus the layer thickness of the applied layer during the coating process.

This task is solved in a coating apparatus unit of the type mentioned at the beginning in that the process analysis tool is designed to measure the active ingredient content of the granules, which is forwarded to the evaluation unit, so that the increase in mass of the granules can be determined in the evaluation unit by means of the coating agent applied to the granules, taking into account the measured active ingredient content of the granules. Advantageously, the preferred coating apparatus unit provides the possibility to determine the mass increase of the coating applied to the granules by means of the sprayed coating agent and thus to influence and adjust the coating process accordingly in order to obtain an optimal drug release profile for the produced granules. In addition, it is relatively easy for the strictly regulated pharmaceutical industry to integrate the coating apparatus unit into existing processes in the production of coated granules and thus further optimize them. Offline measurement or online measurement of the active ingredient content, e.g. during a coating process, is essential for determining the mass increase of the granules, as the active ingredient content decreases with increasing mass of the functional coating applied to the granules. It is therefore now possible to produce granules which, in addition to a defined active ingredient content, comprise a layer thickness of a coating agent applied to the granules that is optimal for a desired active ingredient release profile.

According to an advantageous embodiment of the coating apparatus unit in this respect, the evaluation unit is part of a control device comprising a closed loop control functionality, which is configured to control the coating process taking into account the measured active ingredient content. The advantage of controlling the coating process taking into account the measured active ingredient content is that an optimized active ingredient release profile can be obtained on the granules.

The coating process can also be controlled taking into account the specific layer thickness. Here too, the optimized coating of the granules will result in an optimized active ingredient release profile.

According to a further advantageous embodiment of the coating apparatus unit in this respect, the control device is further configured to determine a deviation between an active ingredient content target value and the active ingredient content measured as the active ingredient content actual value and to use the determined deviation to determine a correcting variable and to forward it to the spraying device. In the same way, it is possible to determine the deviation between the layer thickness target value and the layer thickness actual value and to use the determined deviation to determine a correcting variable and forward it to the spraying device. In both cases, it is possible to produce functionally coated granules with an optimized layer thickness, which in turn comprises an optimized active ingredient release profile.

According to a further development of the coating apparatus unit, the spraying device is configured to be controllable or controlled by the correcting variable forwarded to the spraying device by the control device. Preferably, the spraying device is configured so that a spray gas pressure of the spraying device or the spray rate of the spraying device can be controlled or is controlled by the correcting variable of the control device. Due to the advantageously designed coating apparatus unit comprising a control device, it is now possible to detect the active ingredient content inline during the coating process using the process analysis tool and to manipu-late the layer thickness of the coating applied to the granules during the manufacturing process via the control device connected to the spraying device. Preferably, the droplet size of the sprayed droplets is controlled by adjusting the spraying gas flow in the spraying device or by setting the spray rate, i.e. the flow rate of the at least one liquid to be sprayed, in the spraying device.

According to an additional advantageous embodiment of the coating apparatus unit, the control device comprises an active ingredient content tolerance value and is configured to produce the granules with an active ingredient content within the active ingredient content tolerance value. It is also possible to store a layer-thickness tolerance value in the control device and, with the corresponding control of the spraying device, to obtain granules with a defined active ingredient content and at the same time with a layer thickness optimized for a specific active ingredient release profile. This makes the coating process even more effective, as the coating process only has to achieve a predefined accuracy.

According to a further embodiment of the coating apparatus unit, the spraying device comprises at least one spraying element. In this respect, the spray element is designed as a multi-substance nozzle. Expediently, the spraying device is designed as a top and/or bottom spraying unit and/or tangential spraying unit. Preferably, the spraying device comprises at least one spraying element. The spray element is particularly preferably designed as a multi-substance nozzle. The spraying device is particularly preferably designed as a top and/or bottom spraying unit. This makes it possible to spray the solid particles in the solid particle bed of the fluidization chamber in an optimized manner at all times and thus improve treatment.

According to a preferred further development of the coating apparatus unit, the coating apparatus is designed as a drum coater or as a fluidizing apparatus, wherein the fluidizing apparatus is expediently designed as a fluidized bed or spouted bed apparatus.

According to an additional advantageous embodiment of the coating apparatus unit, the process analysis tool is designed as a measuring device for spectrally spatially resolved detection of the VIS-NIR absorption spectra, expediently as a VIS-NIR hyperspectral camera. Preferably, the measuring device is configured to detect VIS-NIR absorption spectra in a wavelength range between 250 nm and 2700 nm, expediently between 550 nm and 1700 nm. Surprisingly, it has been found that the active ingredient content can be detected in an optimized manner in these wavelength ranges.

Further preferably, the coating apparatus unit is designed in such a way that the coating apparatus comprises the process analysis tool, wherein the process analysis tool is expediently arranged in the coating chamber or a coating chamber bypass. Such an arrangement of the process analysis tool enables optimized detection of the active ingredient content during the coating process. Moreover, process analysis tools arranged in the coating chamber bypass are not directly exposed to the coating agent and thus comprise a longer service life and improved detection properties.

Furthermore, the evaluation unit is preferably connected to the process analysis tool, expediently via a data line. This enables automated evaluation.

According to an additional advantageous design of the coating apparatus unit, the evaluation unit is configured to determine a layer thickness of a coating agent layer applied to the granules from the increase in mass of the granules. Such knowledge of the layer thickness additionally improves the active ingredient release profile and the layer thickness of the coating does not have to be detected in a subsequent complex quality control step.

Furthermore, in a method of the type mentioned at the beginning, this task is solved in that the process analysis tool measures the active ingredient content of the granules and this is forwarded to the evaluation unit, so that the increase in mass of the granules is determined in the evaluation unit by means of the coating agent applied to the granules, taking into account the measured active ingredient content of the granules. The preferred method advantageously provides the possibility of indirectly measuring the layer thickness of the coating applied to the granules by means of the sprayed coating agent in the coating apparatus by means of the active ingredient content and thus manipulating and adapting the coating process accordingly in order to obtain an optimized active ingredient release profile for the granules produced. The online measurement of the active ingredient content during a coating process is essential for determining the layer thickness, as the active ingredient content decreases as the layer thickness of the functional coating applied to the granules increases. Thus, it is now possible to provide a method that, in addition to a defined active ingredient content, also produces a layer thickness of a coating agent applied to the granules that is optimized for a desired active ingredient release profile.

In this respect, the evaluation unit is advantageously part of a control device comprising a closed loop control functionality, which controls the coating process taking into account the measured active ingredient content.

Preferably, the control device terminates the coating process when a certain active ingredient content of the granules is obtained.

According to an advantageous embodiment of the method, the control device controls the coating process taking into account the measured active ingredient content by determining a deviation between an active ingredient content target value and the active ingredient content measured as the active ingredient content actual value and using the determined deviation to determine a correcting variable and forwarding it to the spraying device.

In an advantageous method in this respect, the spraying device is configured to be controlled by the correcting variable forwarded to the spraying device by the control device. Preferably, the spraying device is configured so that a spray gas pressure of the spraying device or the spray rate of the spraying device is controlled by the correcting variable of the control device.

Again, the control of the preferred method produces optimally coated granules, which in turn comprise an optimized active ingredient release profile. The method does not necessarily have to be controlled by means of the measured active ingredient content, but can also be controlled by means of the specific layer thickness of the coating applied to the granules.

According to a further advantageous embodiment of the method, the control device comprises an active ingredient content tolerance value and is configured to produce the granules with an active ingredient content within the active ingredient content tolerance value. It is also possible to store a layer-thickness tolerance value in the control device and, with the corresponding control of the spraying device, to obtain granules with a defined active ingredient content and at the same time with a layer thickness optimized for a specific active ingredient release profile.

By specifying a tolerance value, it is possible to control the coating process effectively, for example by terminating the coating process when a value within the tolerance range is obtained.

Further preferably, the process analysis tool is designed as a measuring device for spectrally spatially resolved detection of the VIS-NIR absorption spectra, expediently as a VIS-NIR hyperspectral camera, wherein VIS-NIR absorption spectra are detected in a wavelength range between 250 nm and 2700 nm, expediently between 550 nm and 1700 nm. Surprisingly, it has been found that the active ingredient content can be detected in an optimized manner in these wavelength ranges.

According to a further advantageously designed method, the evaluation unit further determines a layer thickness of a coating agent applied to the granules from the increase in mass of the granules. Such a method additionally improves the active ingredient release profile and the layer thickness of the coating does not have to be determined in a complex subsequent quality control step.

### BRIEF DESCRIPTION OF THE DRAWINGS

The terms FIG., FIGS., FIGURE, and FIGURES are used interchangeably in the specification to refer to the corresponding figures in the drawings.

In the following, the invention is described in more detail with reference to the enclosed drawing, in which it is shown

FIG. 1 a schematic illustration of a first embodiment of a coating apparatus unit with a coating apparatus designed as a fluidized bed apparatus and a spraying device designed as a top spraying unit,

FIG. 2 a schematic illustration of a second embodiment of a coating apparatus unit with a coating apparatus designed as a fluidized bed apparatus and a spraying device designed as a bottom spraying unit, and

FIG. 3 a scatter plot of the predicted active ingredient content over the measured active ingredient content.

### DETAILED DESCRIPTION OF PREFERRED EMBODIMENTS

Unless otherwise specified, the following description refers to all embodiments of a coating apparatus unit 1 illustrated in the drawing for the production of granules functionally coated with a coating agent.

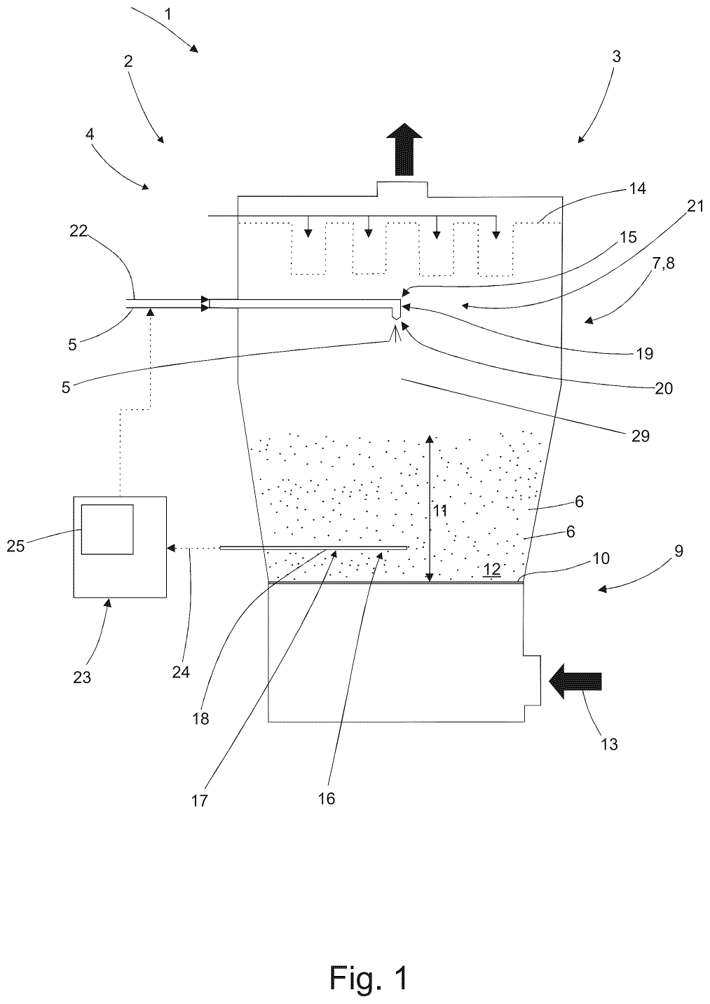

FIG. 1 shows a schematic illustration of a first embodiment of a coating apparatus unit 1. In the first embodiment, the coating apparatus unit 1 is operated as a batch process, i.e. discontinu-ously. Other embodiments not shown here are expediently also operated as continuous coating processes for granules.

The coating apparatus unit 1 comprises a coating apparatus 4 designed as a fluidizing apparatus 2 in the form of a fluidized bed apparatus 3 for producing granules 6 functionally coated with a coating agent 5. In another embodiment, not shown, the coating apparatus 4 is designed as a spouted bed apparatus or as a drum coater.

The fluidizing apparatus 2, which in the first embodiment is designed as a fluidized bed apparatus 3, comprises a fluidizing chamber 8 designed as a coating chamber 7 and a process gas chamber 9 arranged below the fluidizing chamber 8. The fluidizing chamber 8 is separated from the process gas chamber 9 by a gas distributor plate 10. Perforated base plates, for example, are used as the gas distributor plate 10.

In the fluidizing chamber 8, the granules 6 comprising an active ingredient content are produced or these are fed via a granule inlet not shown. The granules 6 are fluidized in a granule bed 12 comprising a granule bed height 11 by a process gas 13 flowing from the process gas chamber 9 into the fluidizing chamber 8. The granule bed height 11 depends on the flow rate or flow velocity of the process gas 13 flowing into the fluidizing chamber 8. After termination of the coating process, the coated granules 6 are discharged from the fluidizing apparatus 2 via a granule discharge, which is also not shown. The process gas 13 is purified by means of a flusha-ble filter 14 arranged in the fluidizing apparatus 2 and, for example, fed back into the process gas chamber 9.

In addition, a controllable spraying device 15 and a process analysis tool 16 are arranged in the fluidizing chamber 8, which is designed as a coating chamber 7.

The process analysis tool 16 is designed as a measuring device 17 for the spectrally spatially resolved detection of the VIS-NIR absorption spectra, expediently as a VIS-NIR hyperspectral camera 18. A Hyperspec® EVNIR from HeadWall Photonics Inc. was used as the VIS-NIR hyperspectral camera 18 in the experiments, wherein this comprised an NIR corrected lens. In this respect, the measuring device 17 is configured to capture VIS-NIR absorption spectra in a wavelength range between 250 nm and 2500 nm, expediently between 550 nm and 1700 nm.

In the first embodiment shown, the active ingredient content is detected as an online measurement directly in the coating chamber 7.

The spraying device 15 comprises at least one spraying element 19, the spraying element 19 preferably being designed as a multi-substance nozzle 20. In the first embodiment, the spraying device 15 is equipped with a spraying element 19 designed as a multi-substance nozzle 20 and is designed as a top spray unit 21.

The spraying device 15 is supplied with the coating agent 5 to be sprayed, in particular pH-dependent and pH-independent polymers, as well as a spray gas 22 comprising a spray gas pressure. By adjusting the spray gas pressure, a droplet size of the droplets of the coating agent 5 sprayed by the spraying device 15 can be adjusted. An adjustment of the droplet size of the droplets sprayed by the spraying device 15 can also be obtained by adjusting the flow rate of the coating agent 5 to be sprayed.

In addition, the coating apparatus unit 1 comprises a control device 23 connected to the spraying device 15 and comprising a closed loop control functionality.

The control device 23 is connected to the process analysis tool 16 by means of a data line 24. The process analysis tool 16 is configured to measure the active ingredient content of the granules and to forward it to an evaluation unit 25 formed as part of the control device 23. In the evaluation unit 25, the increase in mass of the coating agent 5 applied to the granules 6 by means of the sprayed coating agent 5 can be determined, taking into account the measured active ingredient content of the granules 6, and thus also indirectly the layer thickness of the coating. The active ingredient content of the granules 6 measured by the process analysis tool 16 is forwarded from the process analysis tool 16 to the control device 23 as an active ingredient content actual value.

The control device 23 comprising a closed loop control functionality is configured to determine a deviation between an active ingredient content target value and the active ingredient content measured as an active ingredient content actual value. The stored active ingredient content target value, which changes over time, is determined empirically, for example by series of tests.

In the control device 23, the deviation determined is used to determine a correcting variable and this is forwarded to the controllable spraying device 15. Expediently, a function comprising a proportional element and an integral element is used to determine the correcting variable. The correcting variable is used to control the spraying device 15, in particular in such a way that a spray gas pressure of the spraying device 15 or the spray rate of the spraying device 15 can be controlled or is controlled by the correcting variable forwarded to the spraying device 15 by the control device 23. It is also possible to adjust the quantity of coating agent 5 sprayed in order to compensate for any spray losses.

Preferably, the control device 23 comprises an active ingredient content tolerance value and is configured to produce the granules 6 with an active ingredient content within the active ingredient content tolerance value.

In the first embodiment, the spray gas pressure is controlled. This can be used to set a droplet size of the droplets sprayed by the spraying device 15 during the production of the granules 6.

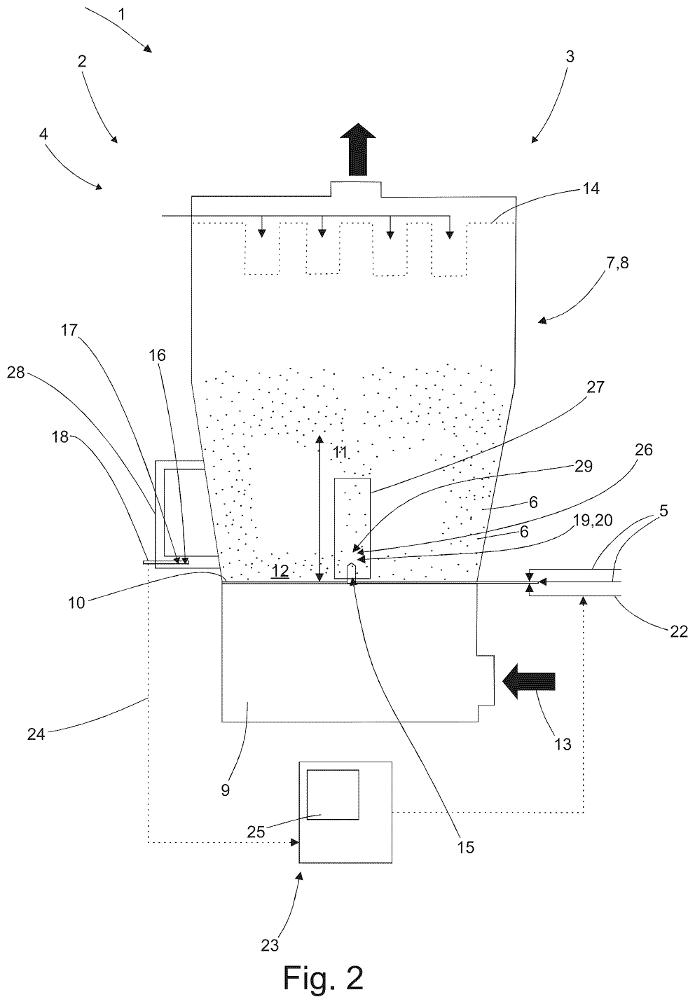

FIG. 2 shows a schematic illustration of a second embodiment of a coating apparatus unit 1.

In the second embodiment, the same components comprise the same reference numerals as in the first embodiment.

In contrast to the first embodiment, the fluidizing apparatus 2 of the coating apparatus unit 1 comprises a bottom spray unit 26 in the form of a bottom spray unit 15 and a vertical riser pipe 27 arranged centrally in the coating chamber 7. Furthermore, the coating chamber 7 comprises a coating chamber bypass 28 in which the process analysis tool 16 is arranged. In the second embodiment, the active ingredient content is thus measured online in the coating chamber bypass 28. The advantage of bottom spray coating (Wurster process) is a very uniform coating, coupled with optimized film quality. This makes the coating process particularly suitable for the targeted functionalization of granules 6, especially in order to obtain defined and reproducible release profiles of an active ingredient.

Bottom spray coating is sprayed from bottom to top. The spray elements 19, expediently the multi-substance nozzles 20, are integrated in the gas distributor plate 10 and thus completely surrounded by product. The combination of gas distributor plate 10 and riser pipe 27 provides a targeted and controlled movement of the granules 6 as a requirement for optimized application of the coating agents 5 to the granules 6.

The uniform retention times of the granules 6 in the spray zone 29 thus ensure a homogeneous film quality and application quantity on the individual granules 6. The granule speed in the riser pipe 27 also generates a high kinetic energy in the granule bed 12, which prevents the granules 6 from sticking together when wet. As a result, even very small granules 6 can be coated without agglomeration. As the bottom spray unit 26 is arranged in the middle of the granulate flow and sprays evenly, premature evaporation of the carrier liquid is also prevented. The result is an optimized film quality for the targeted functionalization of the granules 6.

In a third embodiment, which is not shown but has been realized, the spraying device 15 will be a tangential spraying unit.

In a fourth and fifth non-illustrated embodiment, the measurement of the active ingredient content of the granules (6) is performed as an atline measurement or as an offline measurement.

In a further embodiment comprising an at-line measurement of the active ingredient content of the granules (6), the evaluation unit (25) is designed as a stand-alone solution, so that the evaluation unit (25) can fulfill its function independently, i.e. without further additional devices.

In a first experiment, granules 6 (MCC, Cellets® 200) were produced on the coating apparatus unit 1 according to FIG. 2 (Glatt GPCG 1.1 with 6″ riser pipe 27 (Wurster insert)) using a cellu-lose-based binder and an antitacking agent. granules 6 (MCC, Cellets® 200) were produced using a cellulose-based binder and an anti-tacking agent with the aim of obtaining an active ingredient loading of 50%, wherein a highly soluble active ingredient was used.

In a second experiment, granules 6 were directly granulated on a coating apparatus unit 1 (not shown) using ProCell technology (ProCell 5), wherein this technology enables the production of granules 6 with a high active ingredient content in a spray bed. The active ingredient used for this experiment is the highly soluble active ingredient from the first experiment.

In the second experiment, two types of granules 6 were produced, namely granules 6 without binder and thus with an active ingredient content of 100% and with 5% cellulose-based binder and an active ingredient content of 95%.

All three granule populations were functionally coated with a mixture or sequential coating of two pH-dependent polymers including release agent and plasticizer. When applying the layer comprising a layer thickness as a coating with a mixture of two polymers, proportions of 10 to 60% or 30 to 60% were evaluated in 10% intervals; for the sequential coating, only 30% coating proportions were examined. A total of 16 samples were thus produced, the properties of which are described in more detail in Table 1. The active ingredient content was measured using HPLC and DAD (PV 1741).

Table 1 shows an overview of the 16 samples examined, with the abbreviations W: Wurster, PC: ProCell, seq.: sequential coating, mix: mixture of polymers 1 and 2 applied, PEL: pellets:

| Sample-No. | Method | Degree of coating | Polymer 1/2 |
|---|---|---|---|
| 1 | W PEL (50%) | 30% | seq. |
| 2 | PC PEL (95%) | 30% | seq. |
| 3 | PC PEL (100%) | 10% | mix |
| 4 | PC PEL (100%) | 20% | mix |
| 5 | PC PEL (100%) | 30% | mix |
| 6 | PC PEL (100%) | 40% | mix |
| 7 | PC PEL (100%) | 50% | mix |
| 8 | PC PEL (100%) | 60% | mix |
| 9 | W PEL (50%) | 30% | mix |
| 10 | W PEL (50%) | 40% | mix |
| 11 | W PEL (50%) | 50% | mix |
| 12 | W PEL (50%) | 60% | mix |
| 13 | PC PEL (100%) | 30% | mix |
| 14 | PC PEL (100%) | 40% | mix |
| 15 | PC PEL (100%) | 50% | mix |
| 16 | PC PEL (100%) | 60% | mix |

The detection of VIS-NIR hyperspectral data in the experiments conducted below was carried out with a measuring device 17 (Hyperspec® EVNIR, HeadWall Photonics Inc., wavelength range: 560-1680 nm, spectral resolution 6 nm, spatial resolution 70 um) in push-broom config-uration. It comprises an NIR line scan camera with lens, a spectrograph, a linear drive and a hal-ogen light source. To calculate the absorbance of the samples, a Spectralon® standard with 99% reflectance was measured. For each measured sample, the spatially resolved active ingredient content was calculated from the spatially resolved, pre-processed absorption spectra using PLS regression.

The evaluation is carried out using partial least square regression modeling.

The 16 samples of the coated granules 6 examined were divided into a calibration data set and a test data set in a ratio of 1/1. Only the calibration data set was used in the regression models. The test data set was then used for validation. The regression models were evaluated using the following parameters:
RMSEP: Root Mean Square Error of Prediction
Rank: Number of main components included in the model
R² (coefficient of determination): Coefficient of determination
RPD (residual prediction deviation): the ratio of the standard deviation of the prediction to the standard error of the validation
The optimized calibration model provided the following properties after external validation:
R²=99,82
RMSEP=0,77
Rank=5
RPD=23,9

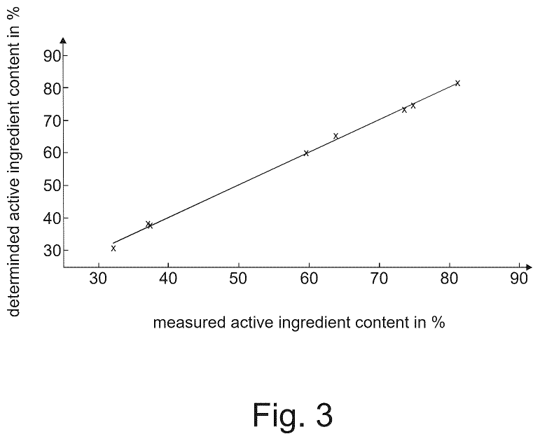

FIG. 3 shows the scatter plot of the active ingredient contents calculated by the calibration model against the active ingredient contents determined by HPLC and DAD (PV 1741) for the test data set.

The actual active ingredient content of sample 4 was 81.35%, and the mean value of the active ingredient content calculated by the calibration model used was 80.9%. For sample 12, the measured and predicted active ingredient contents were 29.33% and 30.5%, respectively.

Due to the very good correlation between measured and predicted active ingredient content, it is possible to measure the active ingredient content during a coating process independently of the coating process carried out, so that the quantity of coating agent 5 applied to the granules 6 can be determined in the evaluation unit 25, taking into account the measured active ingredient content of the granules 6, and thus at least indirectly the layer thickness of the layer applied to the granules 6 by means of the sprayed coating agent 5 can be determined.

The method for producing granules 6 functionally coated with a coating agent 5, comprising a coating apparatus unit 1 with a coating apparatus 4 for coating the granules 6 with the coating agent 5, wherein the coating apparatus 4 comprises a coating chamber 7 and a spraying device 15 arranged in the coating chamber 7 for spraying the coating agent 5, and wherein in the coating chamber 7 the granules 6 comprising an active ingredient content are coated in a coating process by the spraying device 15 with a quantity of coating agent 5 to form a layer comprising a layer thickness, and wherein the coating apparatus unit 1 comprises a process analysis tool 16 and an electronic evaluation unit 25, proceeds in such a way that the process analysis tool 16 measures the active ingredient content of the granules 6 and this is forwarded to the evaluation unit 25, so that the increase in mass of the granules 6 is determined in the evaluation unit 25 by means of the coating agent 5 applied to the granules 6, taking into account the measured active ingredient content of the granules 6.

According to a preferred embodiment, the evaluation unit 25 determines a layer thickness of a coating agent layer applied to the granules 6 from the mass increase of the granules 6.

1. A coating apparatus unit for producing granules functionally coated with a coating agent, comprising:
a coating apparatus for coating the granules with the coating agent, wherein the coating apparatus comprises a coating chamber and a spraying device arranged in the coating chamber (for spraying the coating agent, and wherein in the coating chamber the granules comprising an active ingredient content are or will be coated in a coating process by the spraying device with a quantity of coating agent to form a layer having a layer thickness,
a process analysis tool, and
an electronic evaluation unit, wherein the process analysis tool is designed to measure the active ingredient content of the granules, which is forwarded to the evaluation unit, so that the increase in mass of the granules can be determined in the evaluation unit by means of the coating agent applied to the granules, taking into account the measured active ingredient content of the granules.

2. The coating apparatus unit according to claim 1, wherein the evaluation unit is a part of a control device comprising a closed loop control functionality which is configured to control the coating process taking into account the measured active ingredient content.

3. The coating apparatus unit according to claim 2, wherein the control device is further configured to determine a deviation between an active ingredient content target value and the active ingredient content measured as active ingredient content actual value and to use the determined deviation to determine a correcting variable and to forward it to the spraying device.

4. The coating apparatus unit according to claim 3, wherein the spraying device is configured to be controllable by the correcting variable forwarded to the spraying device by the control device.

5. The coating apparatus unit according to claim 3 wherein the spraying device is configured to control a spray gas pressure of the spraying device or the spray rate of the spraying device by means of the correcting variable of the control device.

6. The coating apparatus unit according to claim 1, wherein the control device comprises an active ingredient content tolerance value and is configured to produce the granules with an active ingredient content within the active ingredient content tolerance value.

7. The coating apparatus unit according to claim 1, wherein the spraying device comprises at least one spraying element.

8. The coating apparatus unit according to claim 7, wherein the spraying element is designed as a multi-substance nozzle.

9. The coating apparatus unit according to claim 1, wherein the spraying device is designed as at least one of: a top spraying unit, a bottom spraying unit, and tangential spraying unit.

10. The coating apparatus unit according to claim 1, wherein the coating apparatus is designed as a drum coater or as a fluidizing apparatus, the fluidizing apparatus expedientiently being designed as a fluidized bed or spouted bed apparatus.

11. The coating apparatus unit according to claim 1, wherein the process analysis tool is designed as a measuring device for spectrally spatially resolved detection of the VIS-NIR absorption spectra, expedientiently as a VIS-NIR hyperspectral camera.

12. (canceled)

13. The coating apparatus unit according to claim 1, wherein the coating apparatus comprises the process analysis tool, wherein the process analysis tool is expediently arranged in the coating chamber or a coating chamber bypass.

14. The coating apparatus unit according to claim 1, wherein the evaluation unit is connected to the process analysis tool, expediently via a data line.

15. The coating apparatus unit according to claim 1, wherein the evaluation unit is configured to further determine, from the increase in mass of the granules, a layer thickness of a layer of coating agent applied to the granules.

16. A method for the production of granules functionally coated with a coating agent, comprising:
operating a coating apparatus unit comprising a coating apparatus to coat the granules with the coating agent, wherein the coating apparatus comprises a coating chamber and a spraying device arranged in the coating chamber for spraying the coating agent, and wherein in the coating chamber the granules comprising an active ingredient content are coated in a coating process by the spraying device with an quantity of coating agent to form a layer having a layer thickness and wherein the coating apparatus unit further comprises a process analysis tool and an electronic evaluation unit wherein the process analysis tool measures the active ingredient content of the granules and this is forwarded to the evaluation unit, so that the increase in mass of the granules is determined in the evaluation unit by means of the coating agent applied to the granules, taking into account the measured active ingredient content of the granules.

17. The method according to claim 16, wherein the evaluation unit is part of a control device comprising a closed loop control functionality which controls the coating process taking into account the measured active ingredient content.

18. The method according to claim 17, wherein the control device terminates the coating process when a certain active ingredient content of the granules is obtained.

19. The method according to claim 17, wherein the control device controls the coating process taking into account the measured active ingredient content by determining a deviation between an active ingredient content target value and the active ingredient content measured as active ingredient content actual value and the determined deviation is used to determine a correcting variable and this is forwarded to the spraying device.

20. The method according to claim 19, wherein the spraying device is configured to be controlled by the correcting variable forwarded to the spraying device by the control device.

21. The method according to claim 19, wherein the spraying device is configured so that a spray gas pressure of the spraying device or the spray rate of the spraying device is controlled by the correcting variable of the control device.

22. The method according to claim 16, wherein the control device comprises an active ingredient content tolerance value and is configured to produce the granules with an active ingredient content within the active ingredient content tolerance value.

23. The method according to claim 16, wherein the process analysis tool is designed as a measuring device for spectrally spatially resolved detection of the VIS-NIR absorption spectra, expediently as a VIS-NIR hyperspectral camera, wherein VIS-NIR absorption spectra are detected in a wavelength range between 250 nm and 2700 nm, expediently between 550 nm and 1700 nm.

24. The method according to claim 16, wherein the evaluation unit further determines a layer thickness of a layer of coating agent applied to the granules from the increase in mass of the granules.
